(19) United States
(12) Patent Application Publication
(10) Pub. No.: US 2006/0004794 A1
(43) Pub. Date: Jan. 5, 2006

(54) Rich application view system and method

(75) Inventors: Michael J. Pizzo, Bellevue, WA (US); Lijiang Fang, Bellevue, WA (US); Johannes Klein, Sammamish, WA (US); Jian Li, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/882,061

(22) Filed: Jun. 30, 2004

(51) Int. Cl. G06F 17/30

(52) U.S. Cl. 707/100

(57) ABSTRACT

The present invention relates to systems and methods to provide rich interaction with persisted data. In particular, an application view is generated for each application and dynamically maintained to provide a rich experience working with data, including but not limited to an ability to scroll through large sets of data while viewing additions, deletions, and other changes made to the underlying data in real-time. According to one aspect of the invention, the application view is generated from a view table that includes aggregates and fully expanded groups at each level and a second table that comprises the expanded/collapsed state of grouped rows.

### TECHNICAL FIELD

The present invention relates generally to computers and more particularly toward facilitating rich interactions between applications and stored data.

### BACKGROUND

Data processing systems are well known in the art. Conventionally, large amounts of data are stored in relational databases. Relational databases organize data into a plurality of tables and include mechanisms to facilitate efficient querying, retrieving, and data processing. In particular, tables are partitioned into rows and columns such that a value exists at the intersection of each row and column. Each column typically contains values of the same data type. For instance, a sales table can consist of columns for the name of the purchaser, the product name, the price, the location, etc. The rows contain values for each of these columns. Data can be retrieved from and provided to tables utilizing structured query language (SQL) statements to communicate with a database server management system (e.g. relational database management system (RDMS)). Accordingly, one can specify a query and receive a set of results in response thereto (e.g., a table of sales data). When the database is quite substantial in size, such processing of data is often referred to as on-line transactional processing (OLTP). For instance, airlines and hotels can utilize OLTP to process reservations and banks as well as automated teller machines (ATMs) can utilize OLTP for electronic fund transfers.

There are several keys to optimizing conventional database transactions. First, queries must be satisfied quickly without blocking others from accessing data. Relational databases are typically set up and utilized by a myriad of people. Hence, when data is being access from a database to satisfy a query or otherwise execute a SQL instruction, the database is locked to guarantee data integrity. In other words, concurrent users of the data must wait to execute their queries until the current action is terminated. Accordingly, it is desirable to execute queries expeditiously to minimize others waiting period. Second, the database must provide a reasonable size of data back to the user as soon as possible so that something can be done with it. For instance, one might query a database to generate a report, perform some calculation or other data processing. In essence, conventional data processing consists of getting in and out of the database as fast as possible to ensure its availability to others.

By contrast, applications require very rich interactions with data. For example, in a typical email application, users desired to scroll up and down through data as well as jump to and from different points in the data. Furthermore, users desire to group related data and sort based on the data members and the grouping of databases. Still further yet, users desire to interact with such data in a very live an interactive fashion. Thus, there is a tension between applications and shared data. That is, applications desire to interact very richly with the data while stores require very well defined interactions with the data that are very strictly scoped in terms of time and amount of data. This can become particularly problematic when confronted with a large amount of data or a potentially large amount of data. Conventionally, what an application will do to enable a user to scroll over say twenty different records is that it will query those records, store them on the client, and then release the database connection. The user can then scroll through the data on the client. Additionally, the user can make changes to the data on the client and then possibly push those changes back to the database. Unfortunately, the conventional paradigm breaks down when you have large amounts of data in part because it is not desirous to have to cache large amounts of data on a client machine. For example, if a user executes a query or search and receives 15,000 hits, it is quite inefficient and unreasonable to read and store all 15,000 hits onto the client's machine before allowing them to scroll through the first three or four that might be of the most interest. In such a case, it might be predictable which data will be of interest, namely the first three or four. However, in other applications, such as email, one could be interested in any data throughout the entire result set. For example, one might specify a query to show all email where certain conditions are met (e.g., received is me). In that case, the user will want to scroll through all the data, but they will not want to store it all on their client device.

Moreover, users want the interaction with data to be very live (e.g., in real-time) so as changes happen they are reflected in the data. For instance, if new data arrives they want to see that data and as data is deleted they want to see such data removed. For instance, when an email goes from the state of unread to read, the displayed mail should go from bolded to un-bolded almost instantaneously. Also, as new mail comes into a user mailbox they want to see it appear. These and other types of rich applications are not supported well by relational databases.

Accordingly, there is a need in the art for a system and method that resolves the tension between applications and shared data, such that rich applications can be employed together with and leverage the benefits of database systems.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Briefly described, the present invention concerns systems and methods that provide a rich experience for interacting with persisted data. In particular, the present invention employs rich cursors over data within a database (also referred to herein as application views) that act as an intermediary between applications and stored data. Use of such views provides support for a feeling of live and dynamic interaction with stored data.

In accordance with one aspect of the invention, the application view can represent expanded and/or collapsed items within grouping levels. So, in an electronic mail program or application one might have mail grouped by sender and might expand or collapse mail from an individual sender. Therefore, the present invention contemplates including organizational data such as the expand/collapse state into a view. Hence, a usage state can be associated with data as well as the data itself.

In accordance with another aspect of the invention, the application view is dynamically maintained so as to reflect changes made to underlying data in real-time. To support such functionality, the present invention proposes the use of standing or stand-by queries (e.g., Wait for), among other things (e.g., triggers, polling, notifications). Standing queries can be specified to monitor particular database tables and/or records for changes (e.g., add, delete, update . . . ). Changes can then be effectuated very rapidly to the database view so as to support the feeling of live data interaction. For example, if an electronic message arrives in an email application, the view should be changed expeditiously to reflect such addition. Furthermore, if data is being viewed on two machines simultaneously and data is deleted on one machine, the deletion should almost immediately be noted on the second machine.

According to yet another aspect of the subject invention, dynamic views, as previously described, can be utilized to support scrolling through large sets of data while viewing changes (e.g., additions, deletions, updates . . . ) to the underlying data by other users as they are made. To support this functionality, temporary tables can be populated with results of a first query. Consequently, as an application scrolls through a view, the present invention simply executes queries against the temporary table populated with the results of the first query. Each query can then return enough data to fill one window or page of data. The view can then be maintained by standing queries against the underlying source and other tables to enable scrolling to be merely a matter of querying against the temporary table.

In accordance with yet another aspect of the invention, a stateless version of the subject invention can be employed. The stateless version trades off round-trip performance for scalability by removing temporary tables. Instead, each application request for a page of results executes the same query that would be used to build the temporary table joined with the expand/collapse state and otherwise filtered to return only those rows required to populate a single page.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of rich application support system in accordance with an aspect of the subject invention.

FIG. 2 is a schematic block diagram of a maintenance component in accordance with an aspect of the present invention.

FIG. 3 is a schematic block diagram of an application view creation system in accordance with an aspect of the subject invention.

FIG. 4 is a schematic block diagram of an application view interaction system in accordance with an aspect of the present invention.

FIG. 5 is a flow chart diagram illustrating a method of rich interaction with persisted data in accordance with an aspect of the subject invention.

FIG. 6 is a flow chart diagram depicting a methodology for instantiating an application view in accordance with an aspect of the present invention.

FIG. 7 is a flow chart diagram illustrating a method of data interaction in accordance with an aspect of the subject invention.

FIG. 8 is a flow chart diagram of a methodology for filtering an application view in accordance with an aspect of the subject invention.

FIG. 9 is a schematic block diagram illustrating a suitable operating environment in accordance with an aspect of the present invention.

FIG. 10 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the subject invention.

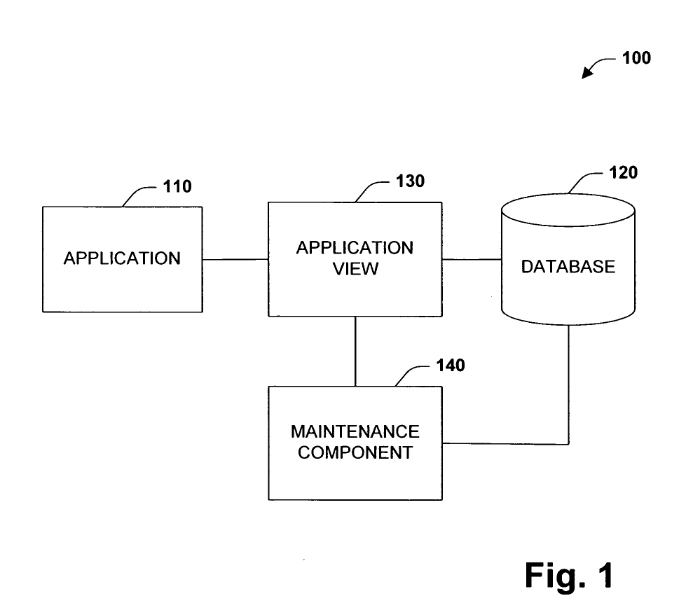

Turning initially to FIG. 1, a rich application support system 100 is depicted in accordance with an aspect of the subject invention. System 100 comprises application 110, database 120, application view 130 and maintenance component 140. Application 110 is an end user program that engages computer machinery via instructions to perform some useful function (e.g., email, file organization . . . ). Database 120 is a combination of hardware and software that facilitates data persistence and retrieval. Accordingly, database 120 can also be referred to as a database management system (DBMS) that provides mechanisms for efficiently entering, organizing, querying, and retrieving data. In accordance with one aspect of the invention, database 120 can be a relational database, which stores and organizes data in formally defined tables. However, the subject invention also contemplates employment of other types of databases including but not limited to a multidimensional database. According to an aspect of the invention, application 110 is rich in the sense that it requires continuous and live interaction with database 120 data rather than quickly connecting to and disconnecting therefrom. Unfortunately, conventional database systems 120 do not readily support such rich interaction. Hence, the subject invention introduces the use of application view 130 to facilitate such communication. In particular, application view 130 can act as an intermediary between an application 110 and database 120 by housing (e.g., storing, caching . . . ) a subset of data with which an application and ultimately a user desire to richly interact. Maintenance component 140 ensures that the application view 130 is synchronized with the database 120, such that relevant view data is updated to correspond to any changes (e.g., add, delete, update) in the database 120.

Application view 130 holds a subset of database information that can be queried against by a user or application 110. The view 130 can be created by specifying a view definition. The view definition can be a particular query itself that upon execution returns a result set of database data that can be utilized as an application view 130. According to an aspect of the present invention, application view 130 can be a temporary or virtual table, which can be queried against rather than base tables of a relational database. Although it is perfectly feasible for the view to be embodied as temporary table, it should also be appreciated that the view can also be a regular persisted table stored on the database 120. This enables the view to be sustained across user sessions or applications instances. With a temporary table, the view can be destroyed upon termination of a user or application session. In either case, interaction with database data is optimized (e.g., less trips to the database) at the expense of the time (e.g., few seconds) that it takes to initially materialize a view. It should further be appreciated that the view does not necessarily need to be materialized and held in memory or persisted to a store. Instead, the view definition can be passed together with a user or application query to be executed by a database 120 query processor. This can significantly increase the scalability of the system 100. However, there is a tradeoff. In particular, improved scalability can come at the cost of reduced responsiveness or liveliness as query processing will take longer than if the view was materialized and queries executed thereon.

It should also be noted and appreciated that application view(s) 130 are significantly different from other conventional database views. In particular, application views 130 are customized or personalized for each user or application instance (e.g., email application). By contrast, conventional views are general and created for employment by a plurality of different users. However, it should be appreciated that application views can be provided to and used by multiple users in a similar yet unique manner. In fact, database views could be employed to facilitate generation of application views. Application views 130 are also much more dynamic than any known database view. For instance, a user may continually change the view definition, which is not conventionally done. Furthermore, the application view definition can be much more complicated than what conventional databases support today. For example, application views 130 can have expanded and collapsed items within a grouping level (described in detail infra). Additionally, any changes made to relevant underlying stored data are perpetuated to the application view 130 as changes are made to the store (i.e., in real time) or very nearly thereafter.

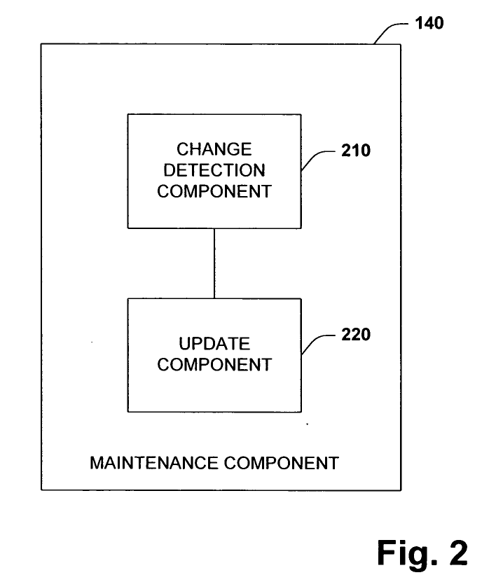

Turning to FIG. 2, a maintenance component 140 is illustrated in further detail in accordance with an aspect of the subject invention. Maintenance component 140 synchronizes the database 120 (FIG. 1) and the application view 130. To facilitate such functionality the maintenance component 140 includes a change detection component 210 and an update component 220. Change detection component 210 monitors the database system 120 (FIG. 1) to determine when a change is made to corresponding view data. A change can include adding a record, deleting a record and/or updating record values. Update component 220 updates the view in response to relevant database changes detected by the change component 210.

There are many ways to detect database changes. For instance, a standing query that completes only when results are available, such as a wait for query, can be specified. For example:

```
WAITFOR(
    SELECT Rows
    FROM MessageTable
    WHERE Receiver = “John Doe” AND Created Time > Current Time
)
```

In such an example, if a row is added to the database where the conditions are met then the statement completes and results can be communicated to the application (and update component 220) associated with the particular view. Alternatively, database triggers can be employed to detect changes. Database triggers can monitor one or more tables and/or records and upon detection of a change in designated data, the trigger can be set. Another declarative approach can be to employ polling. Polling is similar to a standing query, except instead of asking a question of the database once and waiting for a response, the database is periodically queried or polled to determine if particular tables or records have changed. Additionally, it should be noted that query-based change notifications can be utilized to detect changes. Upon materialization of a view, notification can be employed to detect changes in the result set automatically. Thus, instead of declaratively specifying a result that fits a particular criterion, the data is queried and the notification indicates if there is ever a change in the result set it returned. As can be appreciated, each mechanism has advantages and disadvantages over others, but all take advantage of database system speed and efficiencies to detect changes. Once a change is detected, a signal indicative thereof can be transferred and received by update component 220.

Update component 220 can modify the application view so as to reflect changes made to a database. For example, if a record is added to a table, the update component can add the record to the application view. The actual amount of functionality can vary depending upon the detection mechanism employed. For example, a wait for query may detect a change and apply the changed directly to the view. Alternatively, if query-based change notifications are used the change notification provided can be quite vague (e.g., the table of interest has changed). In this situation, the update component may have to determine what change was made, whether it is important in light of the application view data, and if it is, effectuate the change. Consequently, it should be appreciated that while the maintenance component is illustrated as containing two distinct components, change detection component 210 and update component 220, the functionality can be provided by a single component, namely maintenance component 140 (FIG. 1) or a combination of change detection component 210 and update component 220.

According to one aspect of the present invention, the application 110 (FIG. 1) can display pages of scrollable data. For example, the application 110 can correspond to an email program that facilitates receiving, sending, and organizing messages. To aid in understanding various additional aspects of the subject invention, concepts will at times be presented in the context of an exemplary email application. It should be appreciated, however, that the subject invention is not to be construed to be limited to such implementation as it is merely provided as one exemplary manner in which the invention can be employed.

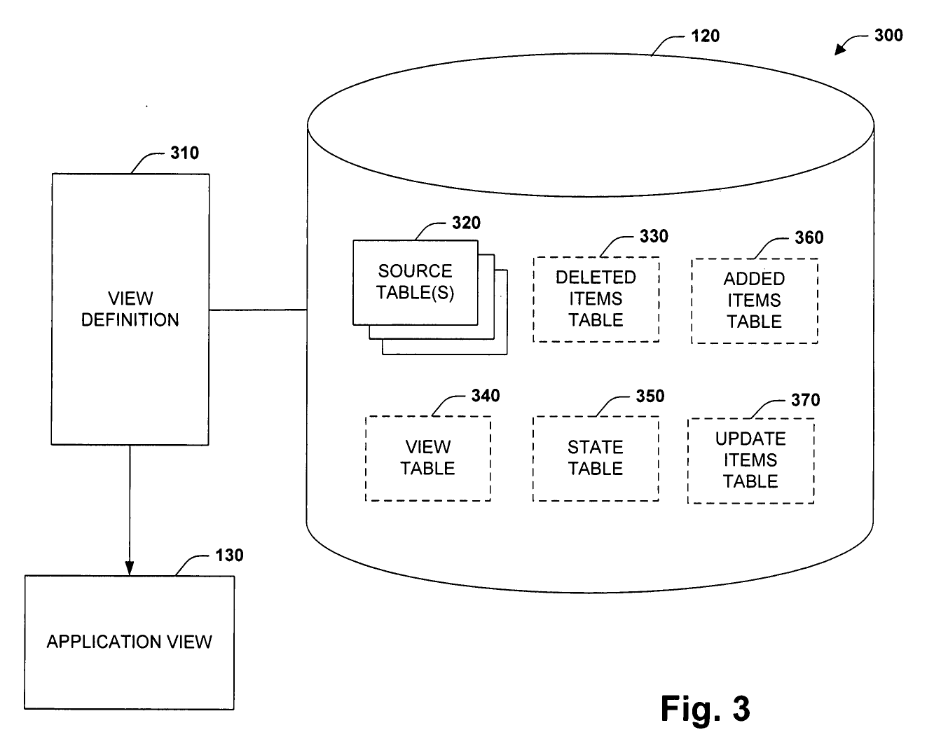

Turning to FIG. 3, an application view creation system 300 is illustrated in accordance with an aspect of the subject invention. System 300 comprises a view definition 310, database 120, source table 320, deleted items table 330, view table 340, state table 350, added items table 360, update items table 370 and application view 130. View definition 310 specifies a query that ultimately generates an application view 130. Such a query can include a multitude of database operations including but not limited to project, aggregate, join, sort, and group. Database system 120 can have six tables associated therewith—source table 320, view table 340, state table 350, deleted items table 330, added items table 360, and update items table 370. Source table(s) 320 house all data that an application or user may need to perform a particular task or set of tasks. View table 340 stores a subset of source data as specified by view definition 310. According to an aspect of the invention, groups and hierarchies are supported. Additionally and in accordance therewith, a user may choose to expand or collapse particular items to facilitate viewing and organization of data. View table 340 can include aggregates and fully expanded groups at each level, thus state table 350 can be employed. State table 350 houses information regarding which information is to be expanded and which information should be collapsed in the application view 130. Deleted items table 330 identifies view data (e.g., records) that have been deleted. Added items table 360 can store newly added data records that meet the view criteria, for example, while update items table 370 can house data records matching the view criteria that have been modified since the creation of the view table 340. In sum, deleted items table 330, added items table 360 and update items table 370 are provided to aid in execution of view maintenance procedures. The application view 130 can then be generated or instantiated by executing a database JOIN operation across all or a portion of the aforementioned tables.

Upon generation of an initial query such as during start-up or prior thereto, an application view 130 should be produced. For example, a user may specify the set of fields, aggregates, filters, sorting and grouping information to be displayed. Based on these parameters, the view definition component can generate a view query representing the user's request. The view query may include additional information (e.g., a row identifier, grouping level, and/or a row number) needed to navigate through or maintain the view table 340. This additional information can be filtered out (e.g., through projections) when returning the information to the application. A row identifier can be used to match rows in the view with deleted or updated rows in the underlying table(s) and can be any field, combination of fields, or value (e.g., rowID) that uniquely identifies a particular row. Group level can be employed to distinguish aggregate rows from detail rows, although other means of identifying aggregate rows (such as having a null id) are also available and are contemplated by the present invention. Row numbers make it easy to position or scroll within the result, although other means of scrolling (such as the use of TOP queries or ranges based on primary key values of adjacent rows) can be employed.

For example, the following <viewQuery> may be generated to express the <fields>, <aggregates>, <orderByFields>, <filter>, and <groupFields> specified by an application for a particular <targetTable>, adding_id and GROUP_LEVEL( ) in order to help the application view navigate through and maintain the results.

```
SELECT
    <fields>,
    t.<pkField> AS _id,
    <aggregates>,
    GROUP_LEVEL( ) as _groupLevel,
FROM <targetTable> t
WHERE <filter>
GROUP BY <groupFields>
WITH ROLLUP;
```

Of course, this is merely one implementation. Those of skill in the art will recognize that there are other ways to implement this as well as other queries provide throughout the detailed description. For instance, an alternative implementation of the above query can be to retrieve the detail rows from the base table first and then add the aggregate rows to the view table in a subsequent query.

By way of example, a common email view may be represented using the following <viewQuery>:

```
SELECT subject, fromName, timeReceived, t.ItemID AS _id,
    count(*) AS msgCount,
    count(CASE IsRead WHEN 0 THEN 1 ELSE NULL END) AS
        unreadCount
    GROUP_LEVEL( ) as _groupLevel,
FROM Messages t
WHERE recipient = @@currentUser
GROUP BY subject, fromName, timeReceived, _id
WITH ROLLUP
```

The application view 130 could submit this <viewQuery> to the database 120 each time the application 110 (FIG. 1) requested data for this view. However, where multiple queries are made against this data for instance when retrieving one screen full of rows at a time, performance can be enhanced by storing the results of this <viewQuery> in a temporary table. It should be appreciated that according to one aspect of the invention the row number could be cached in the temporary table and maintained as rows are inserted, deleted, or their order changes in order to facilitate fetching ranges of rows. Further and in accordance with the above, a clustered index based on the sort order could be applied in order to further improve performance of range-based queries against this data. For example:

```
SELECT <viewQuery> INTO #viewTable;
CREATE CLUSTERED INDEX ON #viewTable(
    <aggregateFields>,
    <orderByFields>
);
```

Maintenance operations can be performed on a manifested view table in response to change events effecting source table(s) 320. In particular, items within the view table can be deleted, added or modified. When it is detected, for example through an ItemsDeletedInDomain( ) procedure that takes a domain of interest (i.e., a table) and a watermark value indicating the last deletion within that domain that the application knows about, that an item(s) has been deleted from a particular table of interest, information about the item(s) (such as the ID) can be temporarily stored to the deleted items table 330 and subsequently used to update the view table 340. For instance:

Create deleted items table

```
CREATE TABLE #deletedItems(
    id uniqueidentifier,
    oldGroupValue varchar(1024));
```

Insert deletions that match our view into the deleted items table when they occur

```
WAITFOR (
    INSERT INTO #deletedItems
    SELECT I.ItemId, V.<groupField>
    FROM ItemsDeletedInDomain(<domain>,
    <lastChangeWaterMark>) I
    INNER JOIN #ViewTable V ON I.ItemId = V._id
);
```

Delete both the summary (aggregated) and deleted rows related to the deleted items

DELETE FROM #viewTable
WHERE (<groupField> IN (select oldGroupValue from #deletedItems)
AND _groupLevel=0)
OR _id IN (select id from #deletedItems);

Insert new summary rows related to the deleted items

```
INSERT INTO #viewTable
    SELECT * FROM (<ViewQuery>) T
    WHERE <groupField> IN (select oldGroup Value from
    #deletedItems)
        AND _groupLevel=0;
```

A query can also be defined in order to watch for additions (such as might be returned by an ItemsAddedToDomain( ) procedure) that affect the view table 340 and ultimately the application view 130. When such a change occurs, it can be logged to an added items table 360 and applied to the view table 340. For example:

Handle item added

```
CREATE TABLE #addedItems(
    id uniqueidentifier,
    newGroupValue varchar(1024));
```

Insert new items that match our view to the added items table when they occur

```
WAITFOR (
    INSERT INTO #addedItems
    SELECT a.ItemId, t.<groupField>
    FROM ItemsAddedToDomain(<domain>,
    <lastChangeWatermark>) a
    INNER JOIN <targetTable> t ON a.ItemId = t._id
);
```

Delete summary rows for added item(s) from view table

```
DELETE FROM #viewTable
WHERE
    <groupField> IN (select newGroupValue from #addedItems)-
        AND) _groupLevel=0
---Insert newly added items and new summary rows
INSERT INTO #viewTable
    SELECT * FROM (<ViewQuery>) T
    WHERE (<groupField> IN (SELECT newGroupValue from
    #addedItems)
            AND) _groupLevel=0)
        OR T._id IN (select id from #addedItems);
```

Similar to deletion and addition, a query can be created in order to watch for changes (e.g., using an ItemsUpdatedInDomain( ) procedure) that would affect the view. When such a change occurs, it can be logged to an updated items table 370 and applied to the view table 340. For instance:

Handle item updated

```
CREATE TABLE #updatedItems(
    id uniqueidentifier,
    oldGroupValue varchar(1024),
    newGroupValue varchar(1024))
```

Insert changed items that match our view to the updated items table when they occur

```
WAITFOR(
    INSERT INTO #updatedItems
    SELECT I.ItemId, V.<groupField>, t.<groupField>
    FROM ItemsUpdatedInDomain(<domain>,
    <lastChangeWatermark>) I
    INNER JOIN #ViewTable V ON I.ItemId = V._id
    INNER JOIN <targetTable> t ON I.ItemId = t._id
);
```

Remove summary and detail rows that have changed

```
DELETE FROM #viewTable
    WHERE
        (<groupField> IN (
                SELECT newGroupValue FROM #updatedItems
                UNION
                SELECT oldGroupValue FROM #updatedItems)
            AND _groupLevel=0)
        OR _id in (select Id from #updatedItems);
```

Insert new values for changed summary and detail rows

```
INSERT INTO #viewTable
    SELECT * FROM (<view Query>) T
    WHERE (<groupField> IN (
                SELECT newGroupValue from #addedItems
                UNION
                SELECT oldGroupValue FROM #updatedItems)
                AND _groupLevel=0)
            OR T._id IN (select Id from #updatedItems);
```

The same mechanism used to maintain the view table 340 can be used to notify the application of changes that occur to application view. These notifications may be over the entire application view, or limited to a subset of rows, such as those currently displayed on the screen.
This view table 340 then contains all of the detail rows along with summary rows for each grouping, and may be maintained, for example, through standing queries. However, the subject invention also provides for organizing return of data in groupings, for example. For instance, particular rows of data can be collapsed and viewable only upon subsequent user action, namely expanding the rows. Retrieval of data in this scenario includes not only obtaining a range of rows but also retrieving only those expanded rows that will be viewable by a user. A state table 350 can be employed to keep track of the summary rows to be expanded. A simple state table 350 used to hold state for a single level of grouping may be defined as follows:
CREATE TABLE #stateTable (ExpandValue1<groupedValueType>);

In particular, an application's view 130 can be selected by defining an <ApplicationViewQuery> joining the view table 340 and the state table 350.

SELECT * FROM #viewTable
WHERE (_groupLevel=0) OR
(<groupName> IN (SELECT ExpandValue1 FROM #stateTable))
ORDER BY <groupBy>,<orderBy>

It should also be appreciated that users of the system of the present invention can interact with the application view 130 to specify groups to be expanded or collapsed. For example, application view 130 can receive information concerning a group to be expanded and then insert or alter a value in the state table 350 to indicate that the group is to be expanded. For instance:
INSERT INTO #stateTable (ExpandValue1) VALUES (@expandValue1)
Similarly, the application view 130 can receive a command to collapse a group and subsequently delete or alter a value in the state table 350 to effectuate the change. For example:
DELETE FROM #stateTable WHERE ExpandValue1=@expandValue1
Hence, the proper application view 130 can be returned when the view table 340 is joined with the state table 350 in response to a user request.

Additionally, it should be appreciated that the state table 350 need not be employed to return expanded and collapsed views. Joining the view table 340 and the state table 350 is merely one means to such an end. The invention is not to be construed to be limited to this particular implementation. For example, the view table itself can include an indication of the expanded and collapsed state of groups (e.g., additional expand/collapse column) thereby eliminating the need for an additional table to store such information. In another example, the set of expanded groups could be kept on the client and specified as part of each query made against the view table. In either case, the <ApplicationViewQuery> could be defined against the view table 340 or against the <viewQuery> directly.

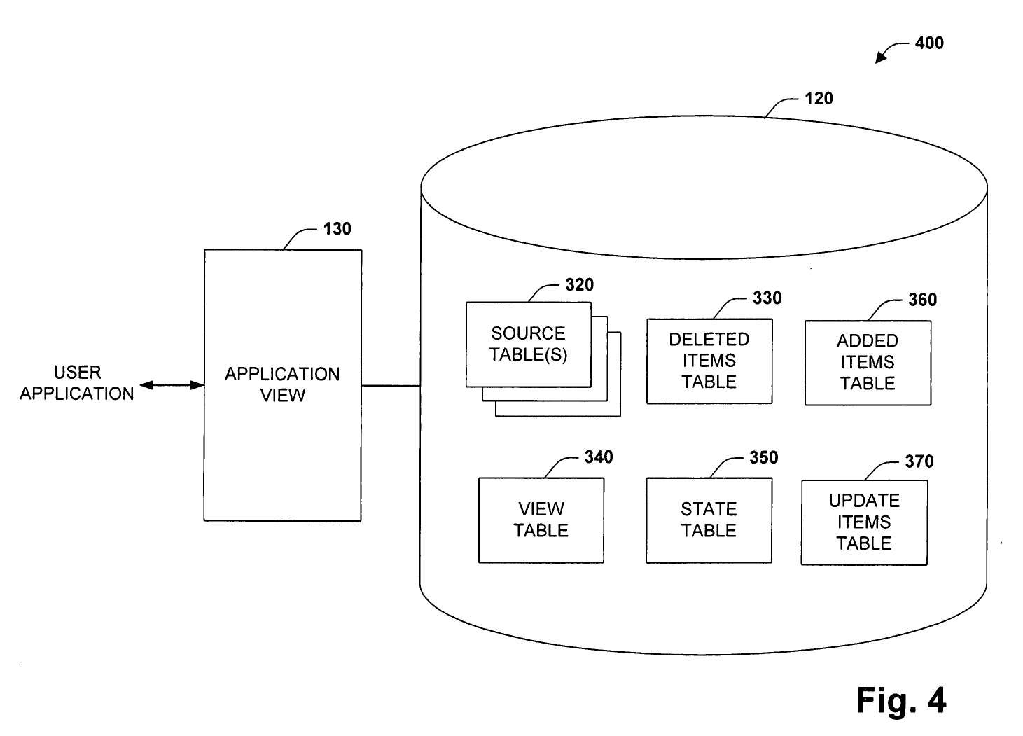

Turning to FIG. 4, a system 400 for interacting with an application view is depicted in accordance with an aspect of the subject invention. The system 410 includes database 120 and application view 130. The subject invention can be utilized to retrieve data from database 120. In accordance with an aspect of the invention, application view 130 can be employed to facilitate retrieval of a range of rows (e.g., page of data). Specifically, data can be retrieved by querying the application view 130. As will be appreciated by those of skill in the art, there are a plurality of manners of specifying queries on data. For instance, a get range function can be specified to retrieve a range of records starting at a specified index. If the results contain row numbers, the function can implement a query such as follows:

SELECT * FROM <ApplicationViewQuery> AS av
WHERE _rownum>@index AND rownum<@count+@index)

In this query, the starting row is specified by the @index parameter, and the number of rows to retrieve is specified through the @pagesize parameter.

Alternatively, if the results do not contain row numbers, a ROW_NUMBER( ) function may be employed in order to limit the results to a range of records as in the following example:

```
    SELECT * FROM
      (SELECT *, ROW_NUMBER( ) OVER (ORDER BY
<groupByFields>,<orderByFields>)
        AS _rowNum
      FROM <ApplicationViewQuery>) AS t
    WHERE _rowNum > @index AND _rowNum <
    @index+@pagesize
    ORDER BY <groupFields>, <orderByFields>
```

It should be appreciated that other means of selecting a range of rows from the <ApplicationViewQuery> may be specified. For example, the function can implement a TOP query such as follows:

```
SELECT * FROM (
  SELECT TOP @pagesize * FROM (
    SELECT TOP (@pagesize+@index) * FROM (
      <ApplicationViewQuery>
    ) AS t1 ORDER BY <orderBy>
  ) AS t2 ORDER BY <reverseOrderBy>
) AS t3 ORDER BY <orderBy>
```

In this query, <orderBy> is the sort order that matches the clustered index created over the view table, and <reverseOrderBy> is the exact reverse of the order. Additionally, this query can be referred to as a top query in that it limits results to the first N. Accordingly, if one would desire to select the top ten messages from a message table, for example, then they could specify ten and receive the first 10 records. However, it should be appreciated that such a query can also be utilized to get any range of records by selection a top number of records from a bottom section. Accordingly, if one wanted to retrieve rows 500-510, they could specify the bottom ten of the top 510. Additionally it should be appreciated that, in another aspect of the subject invention, the same techniques described above may be employed in order to select a range of rows from the view table 340 in place of the <ApplicationViewQuery>.

In brief, the subject invention maintains an application view 130 of a database 120. The view table 340 (e.g., temporary table) is the mechanism used to define the application view 130 and contains the results of a user query. The database 120 is subsequently monitored such that as changes occur to the store those changes are applied to the view table 340. A separate state table 350 contains information regarding the expand collapse state of a user's view. Furthermore, every time the user scrolls or otherwise requests information, a query can be executed against the view table that joins the view table and the expand/collapse state and just brings back the set of records that a user needs to display on their current screen. As a result, a temporal cost is paid associated with the initial creation of the view table 340 so that subsequent operations against the view table 340 from are fast enough to support a rich user experience scrolling through results without copying them all locally. Additionally, a sort order specified by a user can be applied as a clustered index against that view table so that changing the sort order is much faster than creating that view table the first time, and all operations there against are very fast in part because of the use of a clustered index.

Moreover, while the discussion thus far pertains mostly to all application view data being cached in temporary view tables the present invention also contemplates caching minimal amounts of data necessary to retrieve additional data efficiently from the base tables. For instance, keys can be stored to the respective base table rows as well as data necessary to sort the view tuples in the required order (e.g., the grouping and/or sort columns).

Additionally, while not discussed extensively thus far, it should be noted that a state can be shared amongst multiple consumers. For example, an application could create shared indexes and use those to efficiently extract pre-sorted application view data into the respective tables thus allowing multiple users making use of the same application view shape and thereby share the cost of sorting a large result set. In particular, an application could, for instance, identify a set of data via indexes corresponding to electronic messages received between a particular set of times and utilize that information to more efficiently create application views for different individual users.

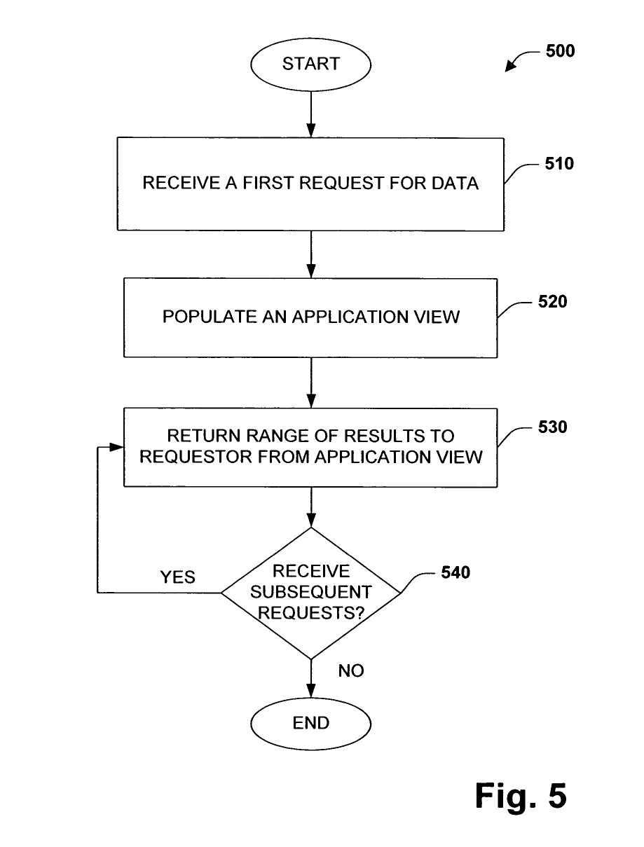

In view of the exemplary system(s) described supra, a methodology that may be implemented in accordance with the present invention will be better appreciated with reference to the flow charts of FIGS. 5-8. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media. By way of illustration and not limitation, the article of manufacture can embody computer readable instructions, data structures, schemas, program modules, and the like.

FIG. 5 depicts a rich method 500 of interacting with data in accordance with an aspect of the subject invention. At 510, a first request for data is received by the system. For example, the request may be for a page of records such as a page of electronic messages. Upon receipt of a request or query, an application view can be populated at 520. The view can be populated with select data from a persistent data store (e.g., structured file system objects, relational database . . . ). At 530, a range of results of a query (e.g., to fill a single screen) are retrieved from the generated application view and returned to the requester. At 540, a determination is made as to whether more data queries have been received. If more requests for data are received then a range of results of the query are retrieved from the application view at 530. The process can then continue to loop until no further queries are received at which point the process terminates. Although, this process is costly by means of the fact that an application view is created first and then queried against, it provides efficiencies related to future queries thereby providing for live interaction with data. Furthermore, it should be noted and appreciated that the initial response time can be improved by first loading the data that is needed by an application and concurrently loading remaining view information in the background.

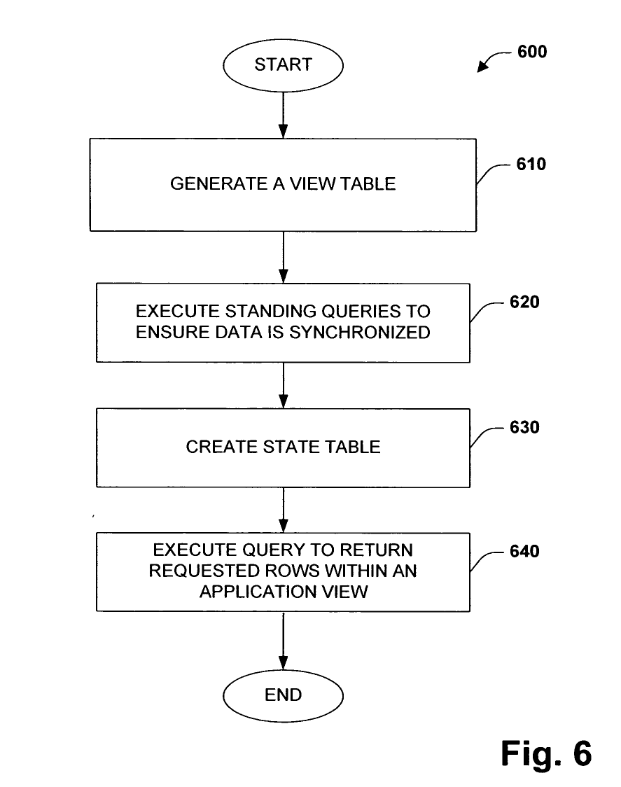

Turning to FIG. 6, a method 600 of manifesting an application view is shown in accordance with an aspect of the invention. At 610, a view table is generated. The view table contains fully expanded subset of data stored in a source table. The view table can be stored in memory as a virtual or temporary table or alternatively persisted to a storage device (e.g., client or server). Standing queries can then be executed at 620 to facilitate synchronization of the application view with changes made to a data store. For example, a query can be executed to determine if any records relevant to the view have been deleted, a second query can check to see if any records germane to the view have been inserted, and a third query can be executed to ensure that view records are updated as they change. It should also be appreciated that tables can be created to house such information (e.g., deleted items, add items, update items) and used to apply the changes to the view table. At 630, a state table can be created expressing the groupings and hierarchical relationships between messages. For instance, the state table can contain information indicating whether each group should be expanded or collapsed. However, as noted previously such information can also be housed in the view table together with record data or provided by the client as part of the query. At 640, the view table, the state table, as well as other information, can be queried to return requested rows within the application view with organized data (e.g., expand/collapse). Users and applications can thereafter utilize the application view rather than a database to interact much more richly with data.

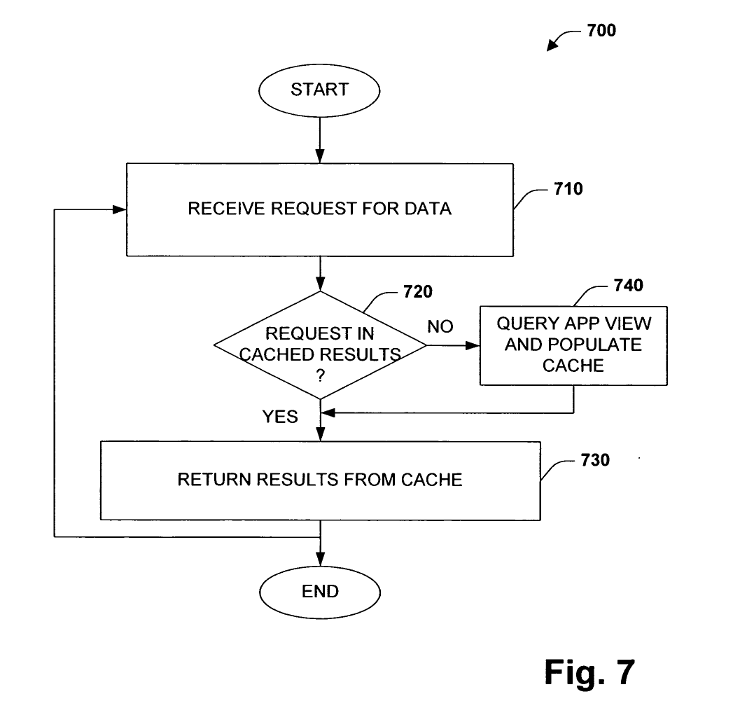

FIG. 7 illustrates another data interaction methodology 700 in accordance with an aspect of the present invention. Methodology 700 picks up after an initial application view has been materialize or generated. At 710, a request is received for data. A request can correspond to a request for a page or one or more individual rows of data. For instance, a user may request a page of email messages, which in turn triggers a request by the email application for data. Upon receipt of a data request, a determination is made as to whether the requested data is in the range of data associated with a cached portion of the application view at 720. If yes, the results can be directly returned from the cached results at 730. If no, the application view is queried for a range of results including the requested rows and those results cached for future use (alternatively a different set of cached results can be reverted to) at 740 and subsequently returned at 730. By way of example, a user may initially request the most recent page of emails. Requests for data in that range could be satisfied expeditiously by simply retrieving information from the cached results and interaction with such data would be quite lively. By contrast, if the database was queried directly the search engine would have to sift through large amounts of unrelated data to find relevant data and then organize the data as desired. Similarly, if a user requests a range of emails outside of the current set of cached rows a new set of cached rows could be generated by querying the same application view to allow the user to interact in a lively manner with such data. Thus, the present invention provides a significant improvement in the speed of returned results within the range of the cached rows, which provides for live and/or rich interaction with data.

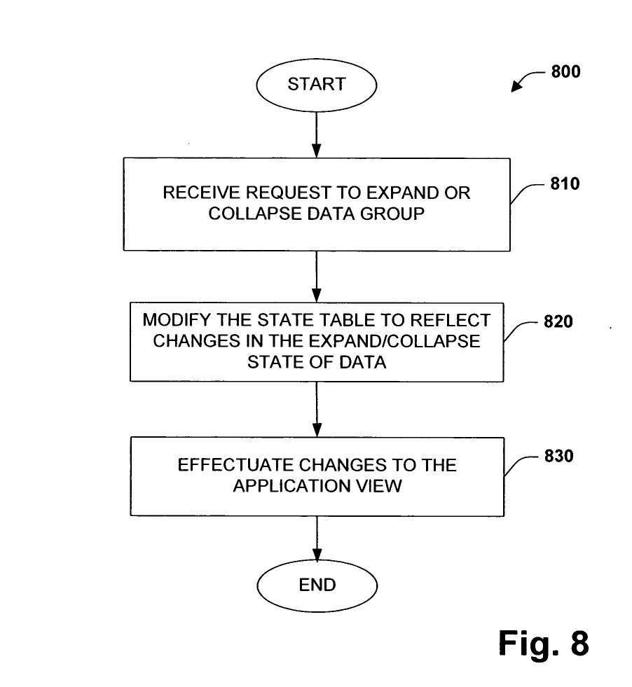

Turning to FIG. 8, a data filtration methodology 800 is illustrated in accordance with an aspect of the subject invention. As mentioned previously, a view table can comprise a subset of a database data representing data relevant to a particular application. Users and application often desire to organize returned results to aid data interpretation. The view table however is not organized according to one aspect of the invention rather it is a fully expanded. Hence, filters can be applied thereto during generation of the application view so that the application view is organized. According to one aspect of the invention, rows of records can be expanded or collapsed. At 810, a request can be received to expand or collapse a data group. For instance, a user may desire to expand the group to view all messages from that same sender by inserting the name of the sender into a state table. Thereafter, the same user may want to collapse all messages from that sender into one record simply specifying the sender's name and some other information by deleting the name of the sender from the state table. Although, it should be appreciated that expand/collapse state data can also be stored and therefore modified in the view table in accordance with an aspect of the invention. Finally, at 830, the changes can be effectuated to the application view, for example, by performing a database join between the view table and the state table.

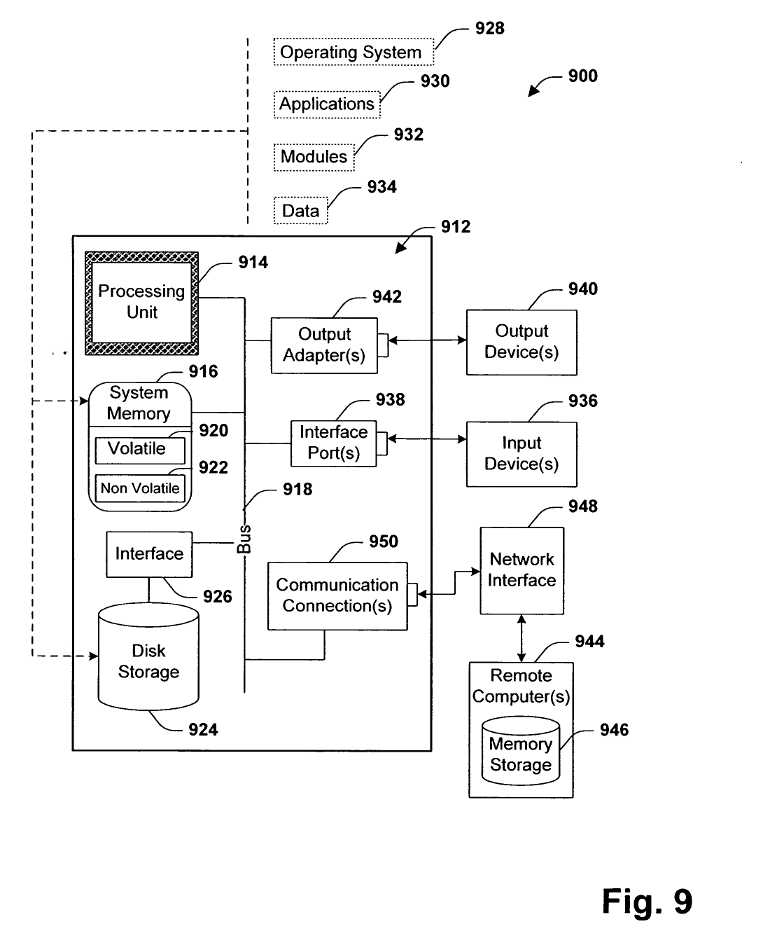

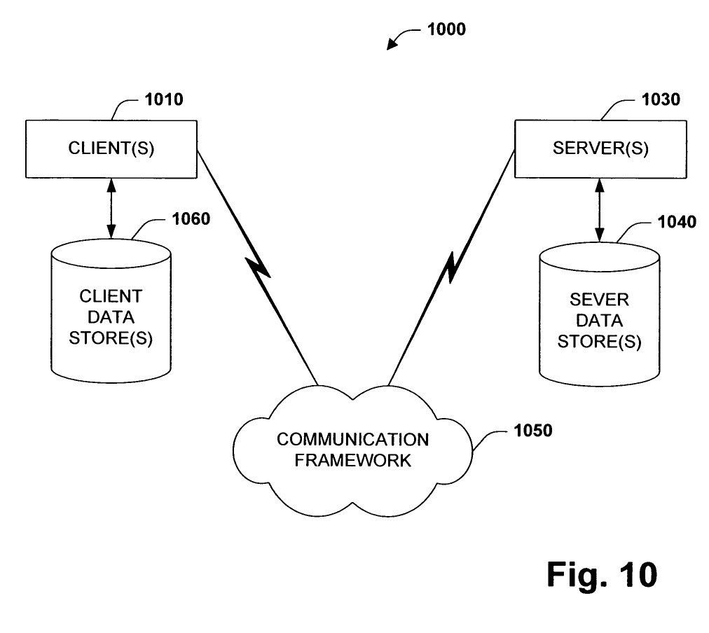

In order to provide a context for the various aspects of the invention, FIGS. 9 and 10 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example disk storage 924. Disk storage 4124 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. Furthermore, it is to be appreciated that the present invention can be implemented with various operating systems or combinations of operating systems.

A user enters commands or information into the computer 912 through input device(s) 936. Input devices 936 include, but are not limited to, a pointing device such as a mouse, trackball, stylus, touch pad, touch screen, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems, DSL modems, power modems, ISDN adapters, and Ethernet cards.

FIG. 10 is a schematic block diagram of a sample-computing environment 1000 with which the present invention can interact. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the present invention, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes or having” is used in either the detailed description or the claims, such term is intended to be inclusive in a manner similar to the term “comprising” as “comprising” is interpreted when employed as a transitional word in a claim.

What is claimed is:

1. A system to support rich application interaction with stored data comprising:
an application view created for use by an application; and
a maintenance component for dynamically updating the view as changes are made to corresponding data in a database, wherein the view facilitates rich interaction with persisted data.

2. The system of claim 1, wherein the view is a temporary table.

3. The system of claim 1, wherein the maintenance component polls the database periodically to determine if the view needs to be updated.

4. The system of claim 1, wherein the database monitors view data and notifies the maintenance component of changes thereto.

5. The system of claim 4, wherein the maintenance component applies the changes to the view.

6. The system of claim 4, wherein the database employs a standing wait for query to monitor data.

7. The system of claim 4, wherein the database utilizes one of a trigger, notification, and polling to detect and indicate the occurrence of a change.

8. The system of claim 1, wherein the maintenance component notifies the application when a change is made to the application view.

9. The system of claim 1, wherein the view is shared by multiple consumers.

10. The system of claim 1, further comprising a view table and a state table to facilitate generation of the view, the state table housing view filtration data.

11. The system of claim 10, wherein the filtration data concerns data groups that can be expanded or collapsed.

12. The system of claim 11, wherein scrolling initiates a join operation between the view table and the state table producing a view that fills a user window.

13. The system of claim 10, wherein multiple state tables are used by different consumers of the same view table.

14. The system of claim 1, wherein the application view caches keys to base table rows and data necessary to sort view tuples in the required order.

15. The system of claim 1, wherein the application creates shared indexes to extract pre-sorted application view data to facilitate the creation of application views for multiple users.

16. The system of claim 1, wherein the application is an electronic mail application.

17. A persistent data interaction system comprising:
a means for generating a unique application view for each application instance that interacts with a database; and
a means for dynamically synchronizing the view with the database.

18. The system of claim 17, wherein the view is a temporary table.

19. The system of claim 17, wherein the view is a dynamically generated at least in part from a view definition upon query execution.

20. The system of claim 17, wherein the view is synchronized by database standing queries.

21. The system of claim 17, wherein the view is synchronized utilizing database triggers.

22. The system of claim 17, wherein the view is synchronized utilizing database polling.

23. The system of claim 17, wherein the view is synchronized employing query notifications.

24. A method of data interaction comprising:
querying an application view associated with an particular application instance; and
receiving results.

25. The method of claim 24, wherein the results are grouped such that portions of the results are expanded and others are collapsed.

26. The method of claim 25, wherein the application view is populated by joining a view table and a state table, the state table containing data designating expanded and collapsed data units.

27. The method of claim 26, wherein the view table is sorted utilizing a clustered index to facilitate expeditious update thereto.

28. The method of claim 24, where the application view is generated dynamically from a query definition upon execution of a query.

29. The method of claim 28, wherein the query definition is stored on a client machine and transferred to a server for query execution.

30. The method of claim 24, further comprising the caching a set of results from the application view.

31. A computer readable medium having stored thereon computer executable instructions for carrying out the method of claim 24.

32. A method of supporting rich client application interactions with databases comprising:
generating an application view for each application session; and
dynamically maintaining the view such that each view and associated database data are synchronized.

33. The method of claim 32, wherein the generation of the application view comprises producing a view table that houses a subset of database data.

34. The method of claim 33, further comprising executing standing queries to synchronize data.

35. The method of claim 34, further comprising creating a state table to indicate an expand/collapse state associated with each data unit.

36. The method of claim 32, further comprising executing queries on the application view to retrieve a range of data to fill a user view.

37. The method of claim 36, wherein executing a query comprises joining a view table comprising a fully expanded set of data and a state table specifying data unit expand/collapse states.

38. A computer readable medium having stored thereon computer executable instructions for carrying out the method of claim 32.
